(19) United States
(12) Patent Application Publication
(10) Pub. No.: US 2002/0170954 A1
(43) Pub. Date: Nov. 21, 2002

(54) Automatic distress notification

(76) Inventors: Joseph P. Zingher, Glendale Heights, IL (US); Abraham R. Zingher, Beach Park, IL (US)

Correspondence Address: Edward K. Runyan, McDonnell Boehnen Hulbert & Berghoff, 32nd Floor, 300 S. Wacker Drive, Chicago, IL, 60606, US

(21) Appl. No.: 10/032,531

(22) Filed: Oct. 24, 2001

Related U.S. Application Data
(60) Provisional application No. 60/243,375, filed on Oct. 26, 2000.
(60) Provisional application No. 60/237,584, filed on Oct. 3, 2000.

(51) Int. Cl. G06F 17/00

(52) U.S. Cl. 235/375

(57) ABSTRACT

A method and apparatus for distress notification. A record of user-specific data, which may include position information and physical characteristic data, may be stored and maintained in a user station. The user station may also include a plurality of telephone numbers or other information about multiple types of emergency service agencies. The information may include, for example, telephone numbers. A user may enter a distress input that indicates a particular type of emergency at the user station, causing the user station to responsively dial the nearest emergency service agency equipped to respond to the indicated type of emergency. The user-specific data may also be transmitted to the called emergency service agency.

### RELATED APPLICATIONS

Priority is claimed to the following Patent Applications:

Pending U.S. patent application Ser. No. 09/927,033, entitled “Biometric System And Method For Detecting Duress Transactions,” filed on Aug. 9, 2001. Application Ser. No. 09/927,033 claims priority to U.S. Provisional Patent Application No. 60/237,584, entitled “Biometric System And Method For Detecting Duress Transactions at Automated Teller Machines,” filed Oct. 3, 2000.

U.S. Provisional Patent Application No. 60/243,375, entitled “Method And System For Automatic Distress Notification And Location,” filed on Oct. 26, 2000.

The entirety of patent application Ser. No. 09/927,033, Nos. 60/237,584, and 60/243,375 is expressly incorporated herein by reference.

### BACKGROUND

1. Field of the Invention

The present invention relates to emergency notification systems and, more particularly, to a method and apparatus for automatic distress notification.

2. Description of the Related Art

In order to perform their functions, emergency response agencies (such as police and fire) need accurate information about potential victims and hazards almost instantaneously. The necessary information breaks down into three types:

(1) a description of the victim(s), for example, his or her gender, height, weight, race, photograph, hair color, etc.

(2) a description of the environment in which the victim(s) is (are) located, such as an address, floor number, building layout, the amount and kind of hazardous materials present (if any), etc.

(3) the type of distress, e.g., fire, robbery, or break-in, etc.

Traditional emergency notification systems may operate by dialing an operator using pre-stored telephone numbers and playing back pre-recorded emergency messages to the operator in the event of an emergency. These systems, however, require the manual updating of the pre-recorded message as conditions change. Unless someone keeps the message current, it may become outdated. Furthermore, these systems do not have any “intelligence” or logic that enables them to, among other things, contact specific agencies according to the location of the emergency, or to transmit information that is up-to-date and related to the type or location of the emergency.

### SUMMARY

The present invention generally relates to a method and apparatus for automatic notification of appropriate emergency service agencies in emergency situations. An exemplary embodiment of the present invention may employ a user station with a local database. The user station may be any device or may be incorporated into any device, such as (without limitation) a PC, alarm system, cell phone, Personal Digital Assistant (PDA), Automated Teller Machine (ATM), or a small, stand-alone device built especially for reporting emergencies and transmitting emergency data. The local database may contain user-specific information, such as an individual's height, weight, and race, or any physical characteristic data relating to the user. The local database may also contain information related to the user's environment, such as building layout, the presence, location, and type of any hazardous materials, and the number and location of other persons who may be present at the scene of an emergency, as well as any information pertinent to those persons that may be of use to an emergency service agency. For example, if the user reports a fire from the user's home, the system may inform the fire department that there may be two adults and two children in the house, as it may also report their possible locations.

If the user station is activated, it may transmit some or all of the information in the local database to an emergency service agency, via a communications network such as the Public-Switched Telephone Network (PSTN) or a radio-access network, or a combination of such networks or other networks. The specific emergency service agency (i.e., the called agency) that the user station contacts may be the closest agency to the user station location.

Alternatively, the user station may transmit identification data rather than the user-specific information to the emergency service agency. The identification data may be, for example, a telephone number and a password. The emergency service agency may use the data to access a remote database known to the agency that contains the same information that the user station would otherwise maintain in its local database and transmit in an emergency. By sending the identification data, the user station does not have to actually transmit private user-specific information during an emergency, and an individual may not have to personally maintain the local database.

These as well as other aspects and advantages of the present invention will become apparent to those of ordinary skill in the art by reading the following detailed description, with appropriate reference to the accompanying drawings.

### BRIEF DESCRIPTION OF THE DRAWINGS

Exemplary embodiments are described herein with reference to the drawings, in which:

FIG. 1 illustrates a simplified conceptual block diagram in which an exemplary embodiment of the present system may be implemented;

FIG. 2 illustrates a simplified conceptual block diagram of a user station suitable for use with the exemplary embodiment; and

FIG. 3 illustrates a set of functions that may be used in conjunction with the exemplary embodiment.

### DETAILED DESCRIPTION OF AN EXEMPLARY EMBODIMENT

An exemplary embodiment and alternative exemplary embodiments of the present invention will be described. It should be understood, however, that the embodiments described are to be considered merely to be exemplary only. The description herein, and the figures, is not intended to limit the spirit and scope of the invention.

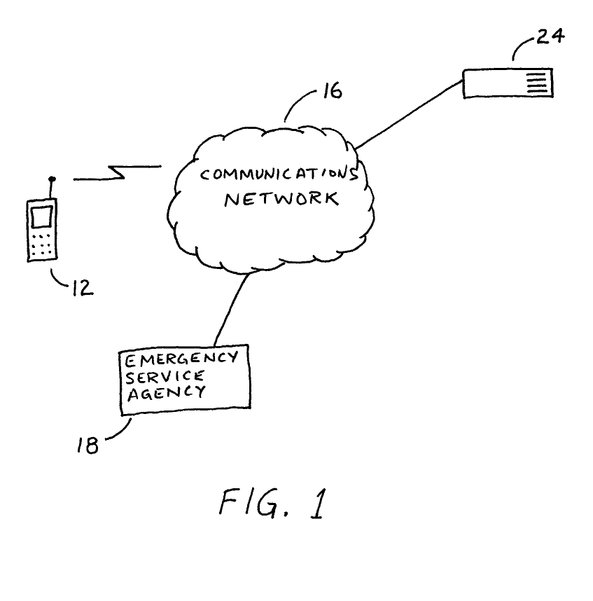

FIG. 1 illustrates an exemplary embodiment of a system for automatic distress notification and location using a local database or, alternatively, a remote database. The system may be comprised of a user station 12 that is capable of communicating with any of several emergency service agencies such as a police department, fire department, hospital, ambulance service, 911 call center, etc., via communications network 16. While user station 12 could communicate with virtually any emergency service agency, for purposes of this discussion the exemplary embodiment will be described with respect to emergency service agency 18, assumed to be the agency closest to user station 12 that is capable of responding to the particular emergency encountered by a user. Communication network 16 may include the Public-Switched Telephone Network (PSTN), a Radio Access Network (RAN), such as a RAN used within a cellular communications network, or any other suitable communications network. User station 12, as well as emergency service agency 18, may also communicate with remote server 24 via communications network 16.

Generally, a user of user station 12, upon recognizing an emergency situation, may enter a distress input into user station 12 corresponding with the type of emergency encountered. User station 12 may then access a local (i.e., onboard) database containing information about the user and about nearby emergency service agencies. By referring to the local database, user station 12 can automatically initiate an emergency call to the nearest emergency service agency (such as emergency service agency 18) that is able to respond to the particular type of emergency. Upon contacting emergency service agency 18, user station 12 may transmit data regarding the type of emergency the user encountered, the user's location, the user's physical characteristics, or any other information that might be helpful to emergency service agency 18.

As an alternative to maintaining a local database, some or all of a user's information could be maintained in a remote server such as remote server 24. Remote server 24 could be a privately owned and operated server or it could be a server operated by a governmental agency such as the National Crime Information Center (NCIC), a state department of motor vehicles, or other agency.

Where remote server 24 is a privately owned server, a user or a third party under contract to the user could enter the user's specific information in an external database within or accessible to remote server 24. The information in the external database could be the same as that contained in a local database as described above. User station 12 could communicate directly with remote server 24 via communications network 16 to cause the user's information to be transmitted to emergency service agency 18.

Where remote server 24 is operated by a government agency or a quasi-government agency, the available information may be different than for a privately owned server. For example, if remote server 24 is a state department of motor vehicles registry, the available information may include the user's address, driver's license number, vehicle identification number, license plate number, vehicle description, etc. This information may be transmitted from remote server 24 to emergency service agency 18 by itself, but it would also be possible to transmit further information about the user from a local database in user station 12 or from another remote server (not shown) to supplement the information from remote server 24.

Typically, a government database such as the NCIC database is not available to the public due to privacy concerns. Because of this, emergency service agency 18's computer may receive identifying information from us 12 and then transmit a request for additional user information to remote server 24. Since emergency service agency 18's computer can meet the NCIC's access requirements, remote server 24 may send the user's information directly to emergency service agency 18.

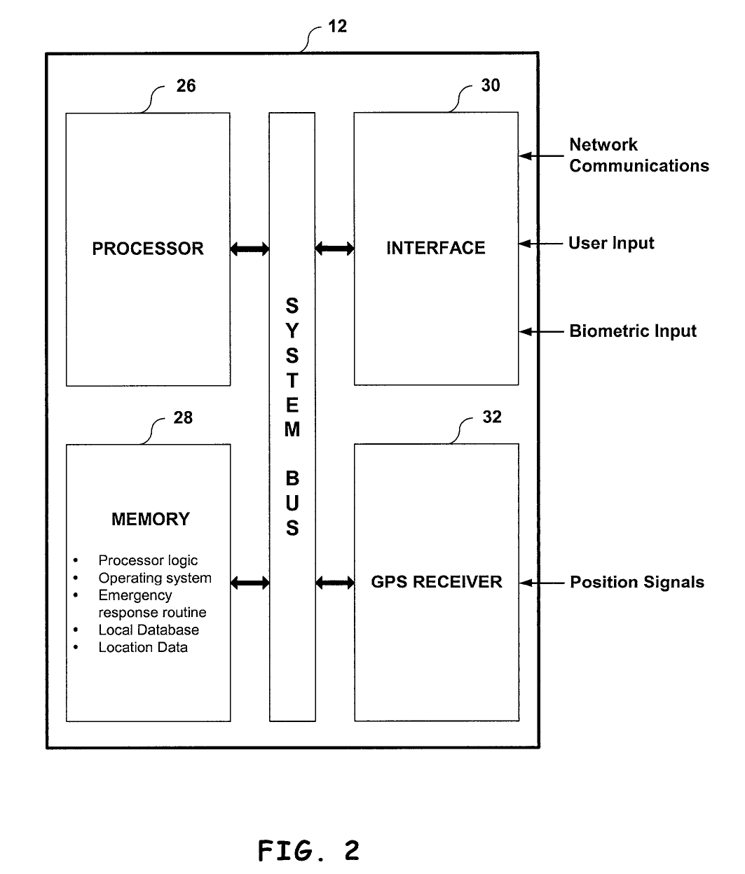

An exemplary embodiment of user station 12 is shown in FIG. 2. User station 12, by way of example, may include a processor 26 (e.g., an integrated circuit microprocessor), a memory 28 (e.g., ROM, flash memory, non-volatile memory, hard disk, etc.), and an interface 30 (which may include both a user interface and a communications interface), all of which may be interconnected by a system bus. This particular configuration is not necessarily critical to the functioning of the exemplary embodiment. For example, the exemplary embodiment could be implemented by a device without a system bus and having a memory and processor contained in one integrated circuit. Further, those skilled in the art will appreciate that many of the elements described in this exemplary embodiment are functional entities that may be implemented as discrete components or in conjunction with other components, in any suitable combination and location.

Although user station 12 may be a PC, a cell phone, or Personal Digital Assistant (PDA), or it may be integrated into an ATM or an alarm system, for purposes of illustration, this description will focus on the operation of the functionality in user station 12 as implemented in a cellular telephone (i.e., a mobile station).

Memory 28 may include more than one physical element, and may also include: an operating system for processor 26; a local database that includes user-specific information and a dynamically updated user location derived, for example, from a positioning system; and a set of stored logic by which processor 26 may refer to data in the local database and initiate communication with an emergency service agency and transmit the user-specific information, as well as the emergency type, to the emergency service agency. User-specific information typically includes physical characteristics of an individual (e.g., height, weight, race, etc.) or environmental conditions (building layout, location, etc.) The exemplary embodiment of the present invention, however, is not restricted in the type of information stored in the database. For example, the database may also include medical information of the user or the user's family members (or others), and it may also include location specific information, such as a building layout both at the user's home and at the user's place of business.

Provided with the present disclosure, those skilled in the art can readily prepare appropriate computer instructions to perform the functions described above.

Interface 30 may include an input keypad for receiving manual user inputs, a biometric reader for receiving biometric inputs, and a display, as well as a communications interface to couple user station 12 with communications network 16. Interface 30 may include a conventional wireless interface (if user station 12 is a mobile station), a modem for connecting to the PSTN, or any other suitable interface for coupling user station 12 with communications network 16.

The keypad may include digit keys such as 0-9 as well as non-numeric keys such as letters a-z, and symbols such as *, #; and it may also include single keys with emergency legends such as “police” “fire” “ambulance”, etc. The keypad may be used to enter a user's input, such as an emergency or distress input. It should be noted that a keypad and display are not crucial to the functioning of the present invention, and that any technology may be used to implement interface 30. For example, a voice recognition/prompting interface or a biometric reader that can recognize a biometric distress input could take the place of a keypad and display. Further, an audible feedback mechanism may be used to provide confirmation of user input, rather than a display.

User station 12 in a mobile embodiment may be a mobile station that includes an integral or external Global Positioning System (GPS) receiver 32. In a GPS system, the GPS receiver could receive position signals from 3 or more GPS satellites and accurately determine its position. Alternatively, user station 12 could receive position information from any other system. The GPS (generically referred to as a positioning system) may be a satellite-based radio navigation system, such as the NAVSTAR global positioning system. The positioning system may also be any land-based or satellite-based system, such as LORAN-C, GLONASS, or any other appropriate positioning system, such as a cellular telephone-based positioning system.

The NAVSTAR GPS which may be used in conjunction with the exemplary embodiment consists of 24 satellites in 6 orbital planes at a height of about 20,000 Km. The satellites are positioned so that a minimum of 5 satellites are “visible” at all times. With position signals from three satellites, a GPS receiver can make an accurate calculation of its position in three dimensions. To calculate a position solution, the GPS receiver measures the propagation delay times of position signals from the satellites to a very high accuracy.

A terrestrial-based positioning system can work in a similar fashion to a GPS, with position signals being received from multiple ground-based transmitters rather than from satellites.

The user station 12 could also be communicatively coupled to a separate GPS receiver or other receiver that could receive position signals as described above. In either case, positioning technology could enable the user station 12 to accurately determine its location and update location data stored in memory 28.

Although the user station, as described above, may operate effectively in mobile environments, as described above, the system can also function statically, where only one telephone number must be stored in the local database for each emergency type. For example, in a static environment, the nearest police station's telephone number could be stored (and thus automatically called) upon a user's initiation of a “police” distress input.

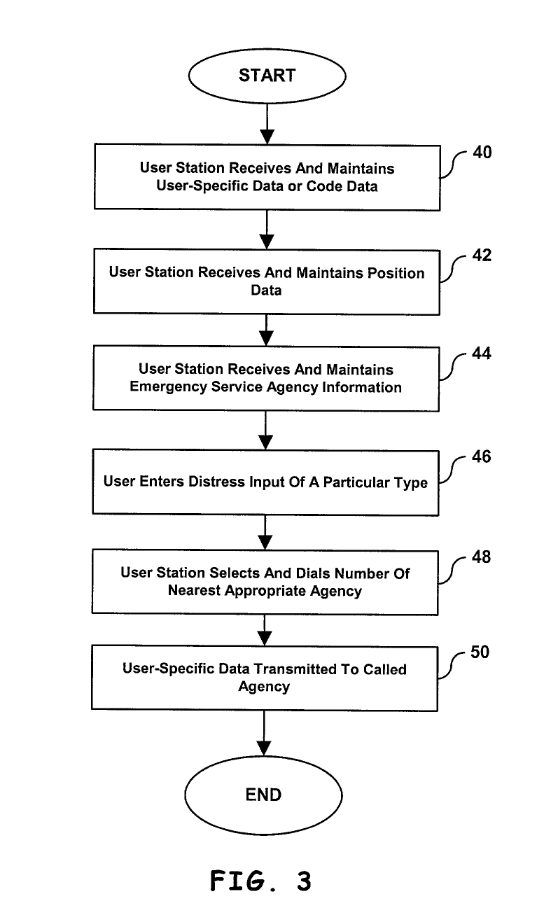

FIG. 3 illustrates a set of functions that may be used in the exemplary embodiment. As shown at step 40, user station 12 can receive and maintain (i.e., update as necessary) user-specific data, including (without limitation) a user's height, weight, gender, hair color, license plate number, etc. The user-specific data could be received directly from the user's input, or it could be received from a separate entity, such as remote server 24, via communications network 16. As the user station is typically in the presence of its user, the user may be required to maintain the local database. He or she, however, may not have the time or diligence to keep the contents of the database current. If the database has inaccurate information, the emergency service agency may not be able to effectively respond to the emergency. Thus, in an alternative exemplary embodiment, the distress system may include a remote database within remote server 24. In a system having a remote database, a user may contract with a third party provider to maintain the accuracy of the database.

If the communications network 16 or if user station 12 has the capability (e.g., GPS), to determine a user's position, the user station 12 may also receive and dynamically maintain a record of its location in memory 28, as shown at step 42. In such an embodiment, the user station's position data may become part of the user-specific data that can be transmitted to an emergency service agency.

As shown at step 44, user station 12 may receive and maintain information (such as telephone numbers) of various types of emergency service agencies near user station 12. The information could be entered by the user at user station 12, or it could be received via interface 30 from any appropriate network entity communicatively coupled to user station 12 via communications network 16. The information about the emergency service agencies could include agency type, location, telephone number, etc., as well as any special equipment or capabilities of the particular agency.

Next, at step 46, the user may enter a distress input at user station 12 indicating a particular type of emergency. For example, the user could press a single button with a legend such as “police” or “fire”, as appropriate to the type of emergency. Alternatively, the user could enter a biometric identification-emergency (BIDE) input at a biometric reader of user station 12. As an example, the user could submit a finger so that the biometric reader could scan the user's fingerprint, where the finger submitted is one with which a biometric distress response (rather than a normal biometric identification) is associated. In the latter example, user-specific data for multiple users of a single user station 12 could be maintained and transmitted, since a BIDE could be used to identify any one of many users of the system.

At step 48, user station 12 could select and dial the telephone number of the nearest appropriate emergency service agency (i.e., a “called” agency) in response to the distress input. Once a connection is made, user station 12 could transmit some or all of the user-specific data to the called agency. Thus, the system would allow a user to quickly contact an agency that deals with the type of emergency encountered (e.g., a police department for a robbery) and rapidly transmit information about the user, including his or her location, to the agency, even where the user station is a mobile station. The agency could then use the information to better respond to the user's emergency.

In an alternative exemplary embodiment, user station 12 may receive and maintain “code data” at step 40 rather than user-specific data. The code data, like the user-specific data, could be stored in memory 28. Code data could include an identification of a remote database (i.e., the remote database within remote server 24) that contains user-specific information and a code. The identification may be a telephone number and the code may be a password, but other identifications and codes are possible. While less comprehensive than the user-specific data that may be stored in a local or external database, the code data would still uniquely identify a user so that the specific information about the user or the user's environment or belongings could be maintained and accessed by a remote server and sent to an emergency service agency when needed.

In the alternative exemplary embodiment, user station 12 could, at step 50, transmit the code data to emergency service agency 18 or directly to remote server 24. The emergency service agency 18 could use the code data to access the remote server 24 or the code data could be used to cause remote server 24 to access the user's information without any input from emergency service agency 18; in either case, remote server 24 could then transmit user-specific data to emergency service agency 18, the user-specific data containing information necessary or useful to emergency service agency 18 to better respond to the emergency. As in the exemplary embodiment, user station 12 may include or communicate with a GPS receiver or have access to a wireless network capable of locating the user station. The user station location may permit the mobile user station to transmit the data to the appropriate (e.g. closest) emergency service agency, such as emergency service agency 18, regardless of the present location of user station 12.

Having a database that is not contained within user station 12 can reduce the internal memory requirements of the user station. Moreover, an external database could contain more information and different kinds of information than would be desirable to store within a local database. For example, an external database may include a tracking database that keeps track of whether a particular person is on the premises, or it may include inventory data that includes the amounts of materials, such as hazardous materials, at a manufacturing plant. The user station may, itself, send the information in the external database to the called agency, or the user station may cause the external database to send it to the called agency. In either case, the emergency service agency may receive critical information so that it can most effectively respond to an emergency.

In an alternate exemplary embodiment, the system may be used to notify emergency service agencies of the location of an ATM machine robbery. Consider the following as one illustration of such an embodiment:

1. An ATM user triggers an emergency routine at the ATM by entering a special duress PIN or a BIDE, or by activating a hidden switch after entering a PIN. The user's trigger is associated with that particular user. A database within the ATM or at a remote server that is part of the ATM network could store user-specific information for a plurality of users. The ATM computer or another computer in communication with the ATM could use the trigger to execute a routine that causes the user's information to be sent to the police station nearest to the ATM. The information sent could include the user's driver's license number, full name, date of birth, and physical description, plus an identifier code, which identifies the particular patrol section for that called police dept.

2. The user's information, as well as police department authorization codes, may also be routed to the National Crime Information Center (N.C.I.C.), Secretary of State's office, or other database used by the particular police dept.

3. A message that a robbery is in progress at the ATM address is also sent directly to the patrol units in the area, as well as an Incident Identifier Number (which could be assigned by any method).

4. A Response from the N.C.I.C./Secretary of State with the victim's identity, description, registered vehicles, and home address, if not stored in the ATM or other non-government database, could be sent to the police station. The time, location, and other details of the robbery may be routed to a police officer's computer.

The U.S. patent application, entitled “Biometric System and Method for Detecting Duress Transactions,” Ser. No. 09/927033, fully incorporated herein by reference, assists in understanding the above illustration. The above-referenced Application describes a method and system for detecting transactions made under duress at ATMs using biometric identifications. In that system, it may be necessary or desirable for apparatus in the ATM to notify an emergency service agency according to the present apparatus and method.

It is to be understood that the embodiments herein described are merely illustrative of the principles of the present invention. Various modifications may be made by those skilled in the art without departing from the spirit and scope of the claims that follow.

1. A method for distress notification comprising:
maintaining a first record of user-specific data;
maintaining a second record comprising a plurality of telephone numbers of a plurality of emergency service agencies, the plurality of emergency service agencies including at least two different types of agencies;
receiving, at a user station, a distress input, the distress input defining a type of emergency;
selecting and dialing one of the plurality of telephone numbers in response to the distress input, the selected telephone number being a telephone number of a called emergency service agency of the same type as the type defined by the distress input; and
transmitting data in the first record to the called emergency service agency.

2. The method of claim 1, wherein the first record is maintained at the user station.

3. The method of claim 1, wherein the second record is maintained at the user station.

4. The method of claim 1, wherein the first record is maintained at a remote server.

5. The method of claim 1, wherein the distress input is a biometric distress identification.

6. The method of claim 1, wherein the user station is a mobile station.

7. The method of claim 6, further comprising:
receiving, at the mobile station, position data defining a location of the mobile station; and
transmitting the position data to the called emergency service agency.

8. The method of claim 7, wherein the position data is satellite GPS data.

9. The method of claim 7, wherein the position data is received at the user station from a terrestrial positioning system.

10. The method of claim 7, wherein the called emergency service agency is selected based on its location relative to the position data;
whereby the called emergency service agency is an emergency service agency closest to the mobile station that is equipped to respond to the type of emergency defined by the distress input.

11. The method of claim 10, wherein the called emergency service agency is an emergency service agency closest to the mobile station that is equipped to respond to the type of emergency defined by the distress input.

12. The method of claim 1, wherein the user station is an ATM.

13. A user station for distress notification comprising:
a processor;
a memory;
a local database stored in the memory, the local database comprising user-specific data, the local database further comprising a plurality of telephone numbers of at least two types of emergency service agencies;
a first emergency routine stored in the memory and executable by the processor to receive user input, the user input defining a type of emergency; and
a second emergency routine stored in the memory and executable by the processor to select and dial one of the plurality of telephone numbers in response to the user input, the selected number defining a called emergency service agency;
the second emergency routine further executable to transmit at least part of the user-specific data to the called emergency service agency;
wherein the called emergency service agency is of a type that corresponds to the type of emergency defined by the user input.

14. The user station of claim 13, wherein the user-specific data further comprises position information, the position information being associated with a location of the user station.

15. The user station of claim 14, further comprising a GPS receiver to receive position signals and to update the position information using the position signals.

16. The user station of claim 14, further comprising an interface to receive position signals via a wireless network with positioning capability and to update the position information using the position signals.

17. The user station of claim 14, further comprising a wireless interface, the user station transmitting at least part of the user-specific data to the called emergency service agency via the wireless interface.

18. The user station of claim 13, further comprising a biometric reader, wherein the user input comprises a biometric duress identification.

19. A system for distress notification comprising:
a remote server, the remote server including a remote database, the remote database including user-specific data and including emergency service agency information; and
a user station, the user station including:
a processor;
a memory;
code data stored in the memory; and
an emergency response routine stored in the memory and executable by the processor to transmit the code data to the remote server, the emergency response routine being executed in response to a user input defining a type of emergency;
wherein the remote server transmits the user-specific data to an emergency service agency in response to receiving the code data.

20. The system of claim 19, wherein the memory includes position information, and wherein the remote server transmits the user-specific data to an emergency service agency that is the closest emergency service agency as indicated by the position information and the user-specific data emergency service agency information.

21. The system of claim 20, wherein the emergency service agency information includes agency types;
wherein the remote server transmits the user-specific data to an emergency service agency of a type that corresponds to the type of emergency.

22. The system of claim 20, wherein the user station is a mobile station.

23. The system of claim 22, wherein the mobile station includes a GPS receiver, the GPS receiver updating the position information as the mobile station moves.

24. The system of claim 22, wherein the mobile station includes a terrestrial positioning receiver, the terrestrial positioning receiver updating the position information as the mobile station moves.

25. The system of claim 19, wherein the user input comprises a biometric distress identification.

26. A method for distress notification comprising:
maintaining a set of records of user-specific data for a plurality of users, each record in the set of records being associated with one of the plurality of users;
receiving a distress input that uniquely identifies one of the plurality of users; and
transmitting at least part of the record associated with the uniquely identified user to an emergency service agency in response to the distress input.

27. The method of claim 26, wherein the distress input is received at an ATM.

28. The method of claim 27, further comprising:
transmitting the location of the ATM to the emergency service agency in response to the distress input.

29. The method of claim 26, further comprising:
receiving position data at a user station; and
transmitting the position data from the user station to the emergency service agency in response to the distress input.

30. The method of claim 26, wherein the distress input comprises a personal identification number.

31. The method of claim 26, wherein the distress input comprises a BIDE.

32. A method for distress notification comprising:
maintaining a set of records of user-specific data for a plurality of users, each record in the set of records being associated with one of the plurality of users;
receiving, at an ATM, a distress input that uniquely identifies one of the plurality of users, the distress input being a BIDE;
transmitting at least part of the record associated with the uniquely identified user to an emergency service agency in response to the distress input; and
transmitting the location of the ATM to the emergency service agency in response to the distress input.
